(19) United States
(12) Patent Application Publication
(10) Pub. No.: US 2010/0187334 A1
(43) Pub. Date: Jul. 29, 2010

(54) DETERGENT INJECTOR FOR PRESSURE WASHER

(76) Inventors: Michael R. Gardner, Anderson, SC (US); Klaus K. Hahn, Braselton, GA (US); Shawn M. Goulding, Greer, SC (US); Jesse J. Jerabek, Anderson, SC (US); Greg Pauken, Grayson, GA (US)

Correspondence Address: MICHAEL, BEST & FRIEDRICH LLP, 100 EAST WISCONSIN AVENUE, SUITE 3300, MILWAUKEE, WI, 53202, US

(21) Appl. No.: 12/691,987

(22) Filed: Jan. 22, 2010

Related U.S. Application Data
(60) Provisional application No. 61/146,765, filed on Jan. 23, 2009.

(51) Int. Cl. B05B 7/26

(52) U.S. Cl. 239/310

(57) ABSTRACT

A pressure washer includes a frame, a power unit supported by the frame, a pump for raising the pressure of a fluid from a fluid source and being driven by the power unit, and a detergent tank positioned upstream of the pump and configured to hold a cleaning solution. The detergent tank is closed from the atmosphere and configured to be pressurized to at least a pressure of the fluid source. The detergent tank has a tank inlet configured to receive the fluid from the fluid source and a tank outlet configured to provide a mixture of the fluid and the cleaning solution to the pump.

### RELATED APPLICATION DATA

This application claims benefit under 35 U.S.C. Section 119(e) of co-pending U.S. Provisional Application No. 61/146,765 filed Jan. 23, 2009, which is fully incorporated herein by reference.

### BACKGROUND

The present invention relates to detergent injectors for high-pressure fluid devices, such as pressure washers.

Some detergent injectors use a post-pump (i.e., downstream) venturi valve that is activated when a user selects a low pressure nozzle. Other post-pump detergent injectors include a high pressure nozzle having a valve that acts as a high pressure venturi at the point of spray. These high pressure injectors are typically bulky because they are located on the spray nozzle and cannot be used with standard nozzles.

### SUMMARY

In one aspect, the invention provides a pressure washer. The pressure washer includes a frame, a power unit supported by the frame, a pump driven by the power unit for raising the pressure of a fluid from a fluid source, and a detergent tank positioned upstream of the pump and configured to hold a cleaning solution. The tank is closed from the atmosphere and configured to be pressurized to at least a pressure of the fluid source. The detergent tank has a tank inlet configured to receive the fluid from the fluid source and a tank outlet configured to provide a mixture of the fluid and the cleaning solution to the pump.

In another aspect, the invention provides a detergent injector. The detergent injector includes an inlet configured to receive a fluid from a fluid source at a pressure greater than atmospheric pressure and an outlet configured to output a mixture of the fluid and a detergent. A detergent tank is positioned between the inlet and the outlet and configured to contain a cleaning solution and receive the fluid at the pressure of the fluid source. A first flow path is between the inlet and the outlet and bypasses the detergent tank, and a second flow path is between the inlet and the outlet and directed through the detergent tank.

In yet another aspect, the invention provides a method of injecting a cleaning solution into a stream of fluid. The method includes receiving a fluid from a fluid source at a pressure greater than atmospheric pressure, directing a first portion of the fluid to a pump, directing a second portion of the fluid separately from the first portion upstream of the pump, mixing the second portion of the fluid with a detergent and then mixing the second portion with the first portion to form a mixture upstream of the pump, and raising the pressure of the mixture in the pump.

### BRIEF DESCRIPTION OF THE DRAWINGS

FIG. 1 shows a detergent injector coupled to a pressure washer, in accordance with the present invention, while detergent is being inserted into the detergent injector.

FIG. 2 shows the detergent injector coupled to the pressure washer of FIG. 1.

FIG. 3A is a top perspective view of the detergent injector of FIG. 2 having a dial in a first position.

FIG. 3B is a top perspective view of the detergent injector of FIG. 2 having the dial in a second position.

FIG. 4 is a side perspective view of the detergent injector of FIG. 2.

FIG. 5A is a cross section of the detergent injector taken along line 5A-5A in FIG. 3A.

FIG. 5B is a cross section of the detergent injector taken along line 5B-5B in FIG. 3B.

FIG. 6 is a cross section of the detergent injector taken along line 6-6 in FIG. 4.

FIG. 7 is a top perspective view of a second embodiment of the detergent injector having a valve unit dial with several positions for adjusting the fluid flow rate into the detergent tank.

FIG. 8 is a top perspective view of the second embodiment of the detergent injector of FIG. 7 having the dial removed.

FIG. 9A is a top perspective view of a third embodiment of the detergent injector having a valve unit with continuous flow adjustment shown in a first position.

FIG. 9B is a top perspective view of the third embodiment showing the valve unit in a second position.

FIG. 10A is a cross section of the detergent injector taken along line 10A-10A of FIG. 9A.

FIG. 10B is a cross section of the detergent injector taken along line 10B-10B of FIG. 9B.

FIG. 11 is a perspective view of a portion of the valve unit of FIGS. 9A-10B.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

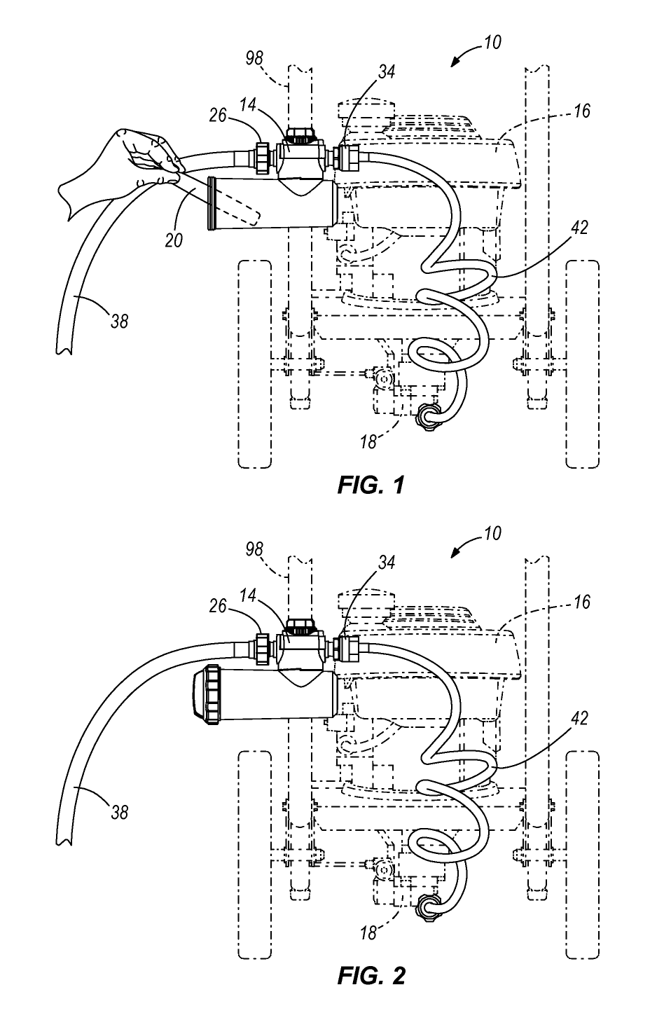

FIGS. 1 and 2 illustrate a pressure washer 10 including a pre-pump (i.e., upstream) detergent injector 14 according to the present invention. The pressure washer 10 includes a power unit 16, such as an engine, that drives a high pressure pump system 18 for increasing the pressure of fluid from a fluid source, such as water from an outdoor residential faucet. An outdoor residential faucet typically provides water between approximately 40-80 psi, which is further pressurized by the high pressure pump system 18. The pressurized fluid can be used for cleaning or other purposes. A detergent pack 20 can be added to the detergent injector 14, as illustrated in FIG. 1, for incorporation with the fluid to provide additional cleaning potential when needed.

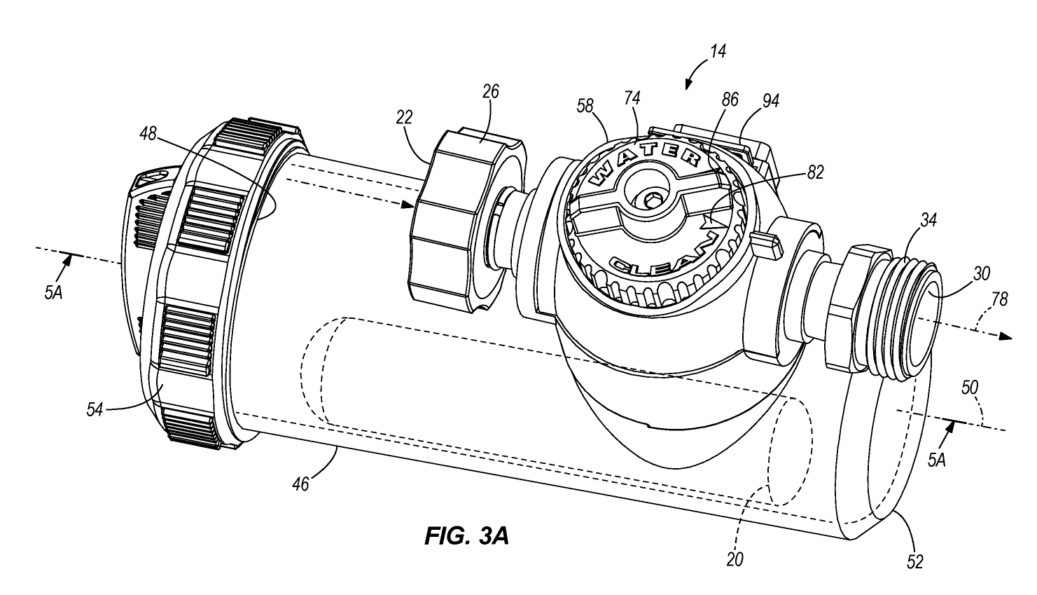

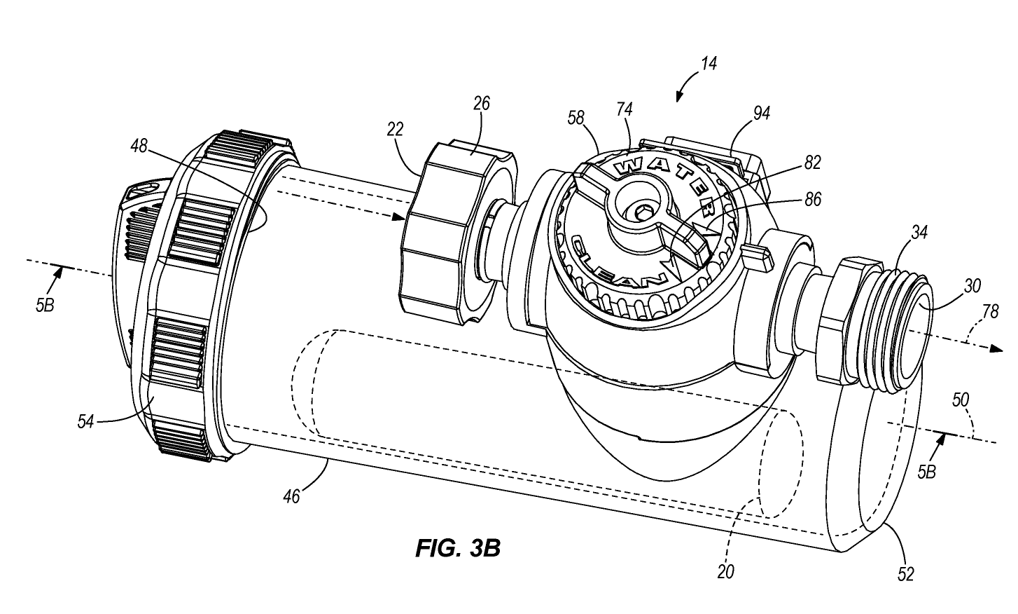

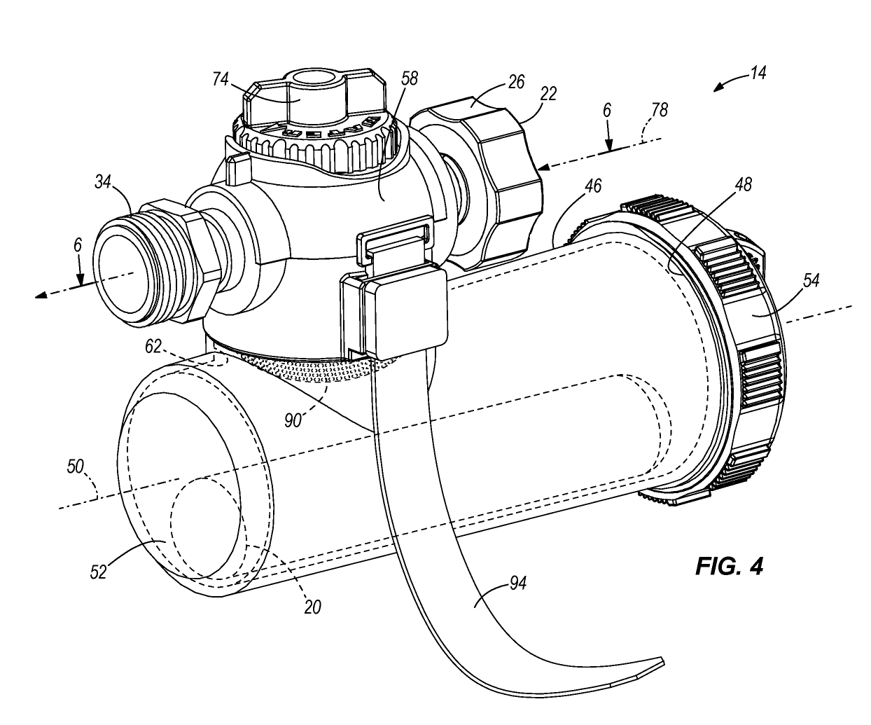

The detergent injector 14 is positioned between the fluid source and the high pressure pump system 18, upstream of the high pressure pump system 18. As better illustrated in FIGS. 3-6, the detergent injector 14 includes a detergent tank 46 and a valve unit 58. The valve unit 58 includes an injector inlet 22 having an inlet connector or fitting 26 and an injector outlet 30 having an outlet connector or fitting 34. The inlet fitting 26 has internal threads and is configured to be connected to the fluid source by way of a fluid conduit 38, such as a garden hose, as shown in FIGS. 1 and 2. The outlet fitting 34 has external threads and is configured to be connected to a second fluid conduit 42, such as a hose, that delivers the fluid to an inlet of the high pressure pump system 18. A main flow stream or flow path is defined between the injector inlet 22 and injector outlet 30, bypassing the detergent tank 46. A secondary flow path is defined between the injector inlet 22 and injector outlet 30 that includes the detergent tank 46, and can be opened and closed as will be described in greater detail below. When the secondary flow path is opened, fluid from the fluid source diverges just downstream of the injector inlet 22 into the main flow path and the secondary flow path, and then converges just upstream of the injector outlet 30. The valve unit 58 and detergent tank 46 will be described in greater detail below.

The detergent injector 14 includes an elongated detergent tank 46 having a central axis 50. In the illustrated construction, the detergent tank 46 is substantially cylindrical and the central axis 50 is substantially horizontal in the normal operating position of pressure washer 10. The detergent tank 46 includes an open end or opening 48 and a closed end wall 52, each lying substantially normal to the central axis 50. Preferably, the detergent tank 46 has an elongated shape having a horizontal central axis in the normal operating position of the pressure washer, and is constructed of a clear material such as plastic. In other constructions, the detergent tank 46 may have another shape suitable for holding detergent, such as another elongated shape or a bowl, or may have a vertically oriented central axis. In yet other constructions, other suitable materials such as metal, opaque plastic or translucent plastic may be employed.

A detergent insertion cap 54 is removably coupled to the detergent tank 46 at the open end 48 and is positioned substantially normal to and centered about the central axis 50. The detergent insertion cap 54 closes the open end 48, thereby sealing the detergent tank 46 from the outside environment and preventing fluid from leaking out of the detergent tank at the open end 48. In the illustrated construction, the detergent insertion cap 54 includes a threaded surface that mates with an opposing threaded surface adjacent the open end 48 of the detergent tank 46. As the detergent tank 46 is positioned upstream of the high pressure pump system 18 and downstream of the fluid source, the detergent tank 46 must be capable of withstanding the pressure of the fluid source, such as a residential utility supply of water at approximately 40-80 psi, without leaking In other constructions, the detergent insertion cap 54 may be sealed to the open end 48 of the detergent tank 46 in another suitable fashion, such as by a snap fit, an interference fit, or the like.

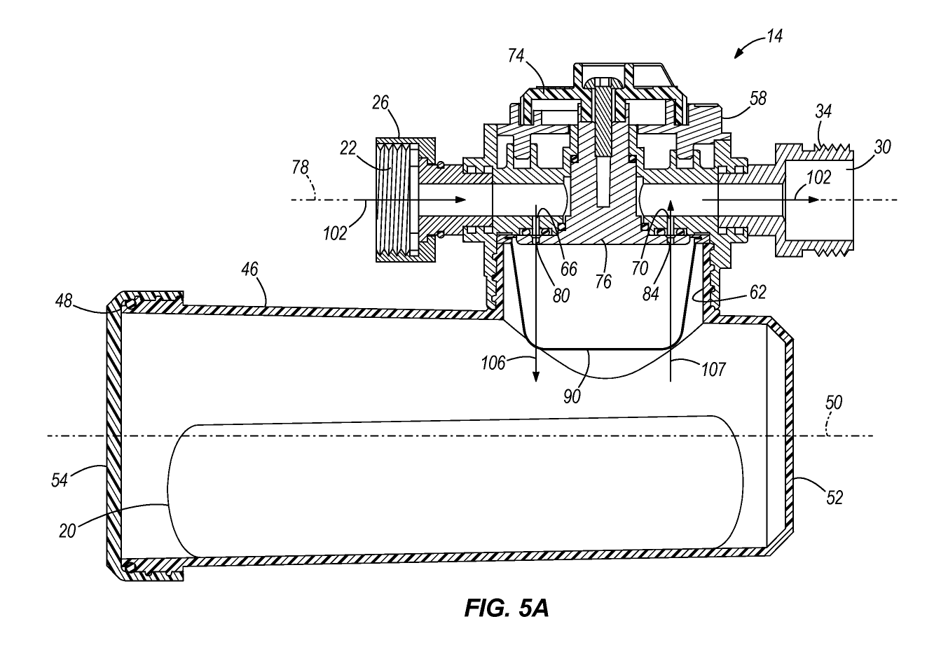

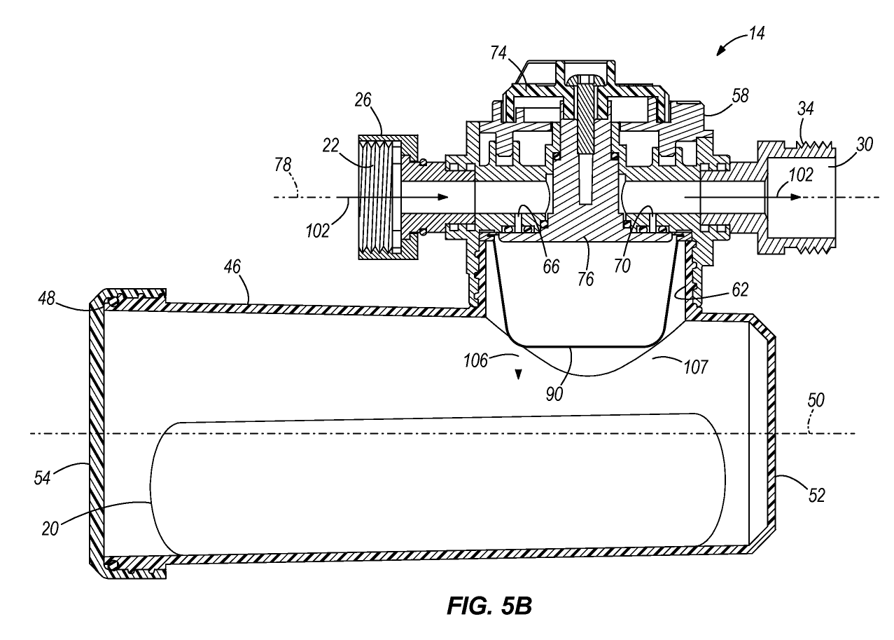

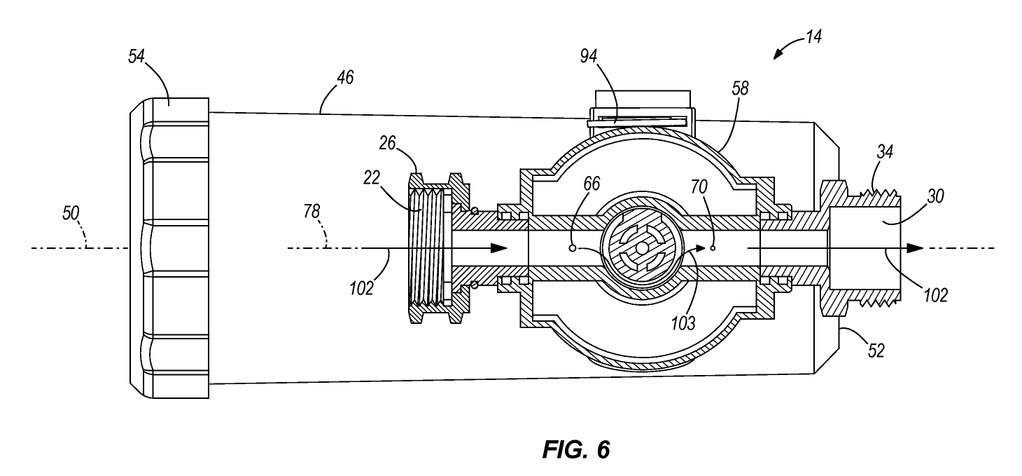

The valve unit 58 is coupled to an opening 62 in the top of a substantially cylindrical portion of the detergent tank 46, preferably by a threaded engagement, and is selectively in fluid communication with the detergent tank 46. In other constructions, the opening 62 may be in the bottom, sides or an axial end of the detergent tank 46. The valve unit 58 includes a tank inlet 66 and a tank outlet 70, best illustrated in FIGS. 5A-6. The tank inlet 66 is preferably a small aperture in the valve unit 58 that fluidly connects the injector inlet 22 with the detergent tank 46 such that a small amount of fluid from the fluid source can enter the detergent tank 46, as indicated by the arrow 106 in FIG. 5A. The tank outlet 70 is preferably a small aperture in the valve unit 58 that fluidly connects the detergent tank 46 with the injector outlet 30 such that a small amount of fluid from the detergent tank 46 can join the main fluid stream just upstream of the injector outlet 30, as indicated by the arrow 107 in FIG. 5A. Unlike prior detergent injectors using venturis, the main fluid stream in the present invention has little, if any, restriction as it follows a substantially linear path through the valve unit 58 along a central axis 78 of the injector inlet 22 and injector outlet 30, as shown by arrows 102. The central axis 78 is preferably substantially parallel to the central axis 50 of the detergent tank 46.

The valve unit 58 includes a control dial 74 rotatable about an axis substantially normal to the central axis 78 of the injector inlet 22 and injector outlet 30. The control dial 74 is rotatable between a first position 82 (FIG. 3A) and a second position 86 (FIG. 3B), indicated by the indicia shown in FIGS. 3A and 3B. The control dial 74 includes a control dial plate 76 having an inlet aperture 80 and an outlet aperture 84. As illustrated in FIGS. 3A and 5A, the control dial 74 is in the first position 82. In the first position 82, the inlet aperture 80 and the outlet aperture 84 are aligned with the tank inlet 66 and the tank outlet 70, respectively. Thus, the tank inlet 66 is unobstructed or open such that a small amount of fluid from the fluid source can enter the detergent tank 46 by way of the tank inlet 66, and a small amount of fluid and detergent from the detergent tank 46 can exit the detergent tank 46 by way of the tank outlet 70 and join the main fluid stream just upstream of the injector outlet 30, as indicated by the arrows in FIG. 5A.

As illustrated in FIGS. 3B and 5B, in the second position 86, the control dial 74 is rotated and the control dial plate 76 obstructs or closes the tank inlet 66 and the tank outlet 70 such that fluid from the fluid source cannot enter the detergent tank 46 by way of the tank inlet 66 and fluid and detergent from the detergent tank 46 cannot exit the detergent tank 46. However, in the second position 86, the fluid is able to pass from the injector inlet 22, around the center of the valve unit 58 and out the injector outlet 30 in a substantially linear path, as described above and shown by arrows 102 and 103 in FIG. 6. In other constructions, other suitable control means for opening and closing the tank inlet and outlet 66, 70 may be employed.

The valve unit 58 also includes a filter or screen 90 covering the tank inlet 66 and the tank outlet 70 to prevent large particles of detergent from the detergent pack 20 from clogging the tank inlet 66 and tank outlet 70, and from being passed to the output nozzle. The screen 90 also prevents large particles of detergent from joining the main fluid stream and traveling to the high pressure pump system 18. The screen 90 is a mesh or a surface with many small openings and separates the tank inlet 66 and tank outlet 70 from the main compartment of the detergent tank 46. The screen 90 also provides a space between the screen 90 and the tank inlet 66 and tank outlet 70 to distance the screen 90 and any particles trapped thereon from the tank inlet 66 and tank outlet 70 openings. The screen 90 may have a suitable shape, such as a closed cylinder, a cone, a bowl, a disk, or the like.

The valve unit 58 also includes a frame strap 94 to attach the detergent injector 14 to the pressure washer frame 98. For convenience, it is preferable that the detergent injector 14 is supported by the pressure washer frame 98 so as to be transportable with the pressure washer frame 98. In the illustrated construction, the frame strap 94 is a thin, flexible strip of material having a securing mechanism to fasten the strap 94 in a closed loop around a portion of the frame 98. The frame strap 94 may include a buckle, hook-and-loop, or other suitable securing mechanism for securing the strap 94 in a closed loop. The frame strap 94 is oriented to fasten the detergent injector 14 to a substantially horizontal member of the pressure washer frame 98. It is to be understood that the frame strap 94 may be oriented differently in order to fasten to a non-horizontal member of the pressure washer frame 98. Preferably, the frame strap 94 is oriented to fasten the detergent injector 14 to the pressure washer frame 98 such that the central axis 50 of the detergent tank 46 and the central axis 78 of the injector inlet 22 and injector outlet 30 are substantially horizontal in the normal operating position of the pressure washer. However, in other constructions, the frame strap 94 may be positioned to orient these axes 50, 78 non-horizontally. In other constructions, other suitable fasteners, such as a clip shaped as a portion of a cylinder to clip onto a tubular portion of the pressure washer frame 98, or the like, may be employed. In yet other constructions, the detergent injector 14 may utilize a different type of fastener to attach to the pressure washer frame 98, such as a bolt, a clamp, a pin, or the like, as are commonly known in the art.

The detergent pack 20 is inserted horizontally into the detergent tank 46 through the open end 48 when the detergent insertion cap 54 is removed. The detergent pack 20 is preferably a solid that dissolves on contact with the fluid and is preferably an elongated shape to fit axially and horizontally within the detergent tank 46. However, other suitable forms of detergent may be employed, such as pellets or a viscous liquid.

In operation, fluid from the fluid source enters the detergent injector 14 upstream of the high pressure pump system 18 by way of the injector inlet 22. When the control dial 74 is set to the first position 82, a small portion of the fluid enters the detergent tank 46 by way of the tank inlet 66 and the inlet aperture 80 in the control dial plate 76. The remainder of the fluid passes through the valve unit 58 to the injector outlet 30 and is referred to herein as the main fluid stream, shown by arrows 102 and 103 (FIGS. 5A and 5B). Fluid in the detergent tank 46 dissolves the detergent pack 20, resulting in a solution of fluid and detergent. When the detergent tank 46 fills and reaches the operating pressure of the fluid source (e.g., 40-80 psi), the fluid and detergent solution exits the detergent tank 46 by way of the outlet aperture 84 in the control dial plate 76 and the tank outlet 70 and joins the main fluid stream 102 in the valve unit 58 at pressure. This stream of solution is referred to herein as the detergent stream 106 (FIG. 5A). The detergent stream 106 flows in tandem, or concurrently, alongside the main fluid stream, thus minimizing cavitation in the pump by preventing outside air from entering the system. Fluid continues to enter and exit the detergent tank 46 as long as the control dial 74 is set to the first position 82. The fluid and detergent solution exits the detergent injector 14 by way of the injector outlet 30 and travels to the high pressure pump system 18. Then, the solution travels to a pressure washer wand and exits a standard nozzle at high pressure when the wand is actuated by the user. Thus, detergent is applied at high pressure because a standard, high pressure small aperture output nozzle may be used, instead of a low pressure, large aperture soaper nozzle that is used when a detergent is dispensed with a typical prior art detergent delivery system.

When the control dial is set to the second position 86, all of the fluid entering the detergent injector 14 exits the detergent injector 14 without passing into or out of the detergent tank 46; i.e., the detergent tank 46 is fluidly disconnected from the main fluid stream 102 in the valve unit 58. Thus, only clean fluid, i.e., fluid from the fluid source, enters the high pressure pump system 18 per normal.

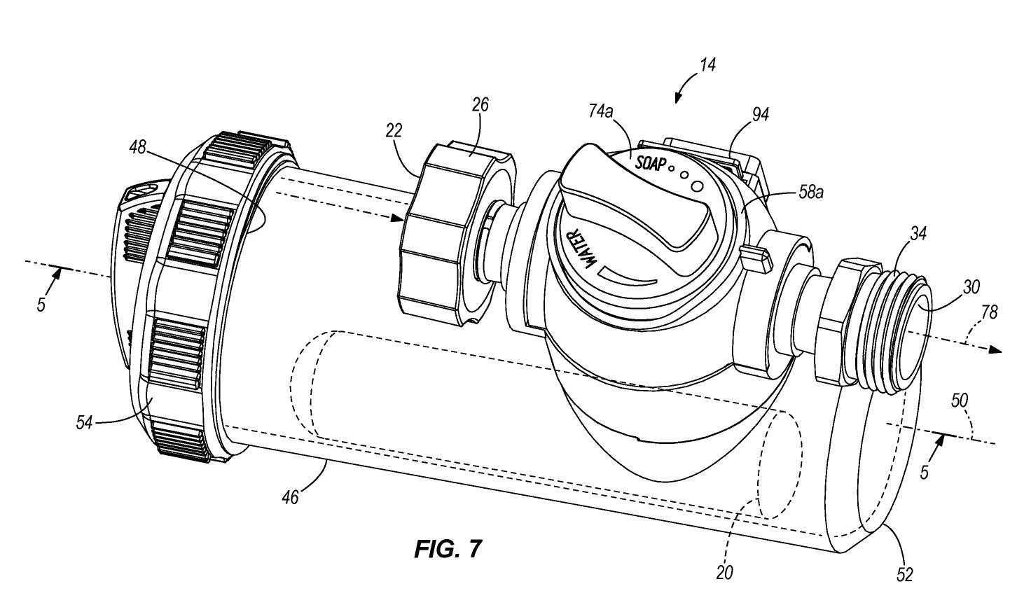

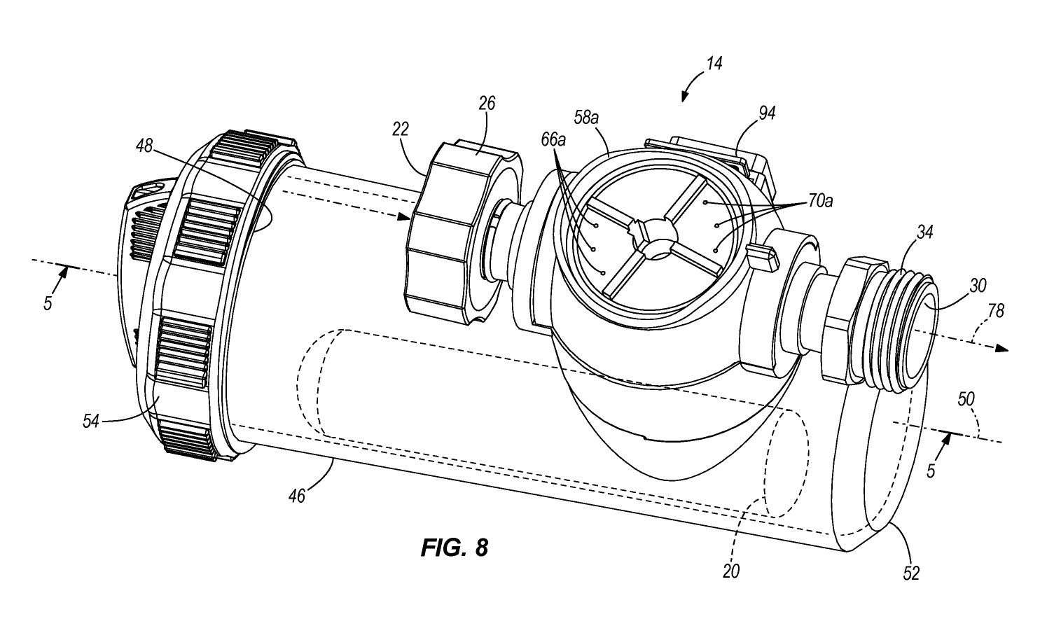

FIGS. 7 and 8 relate to a second embodiment of the valve unit. Valve unit 58a in FIGS. 7 and 8 is similar to valve unit 58 in FIGS. 1-6 except that valve unit 58a has multiple positions to set various rates of fluid entry into and exit from detergent tank 46. This feature enables regulated soap injection into the main fluid stream. In FIGS. 7 and 8, valve unit 58a has a control dial 74a that is rotatable to multiple positions, thereby regulating the rate of water that enters detergent tank 46 through tank inlet apertures 66a and also the rate of the water/detergent mixture that exits the detergent tank 46 through tank outlet apertures 70a. This regulation may be achieved by changing the sizes of apertures 66a and 70a, or by changing the number of apertures 66a and 70a that are open or obstructed.

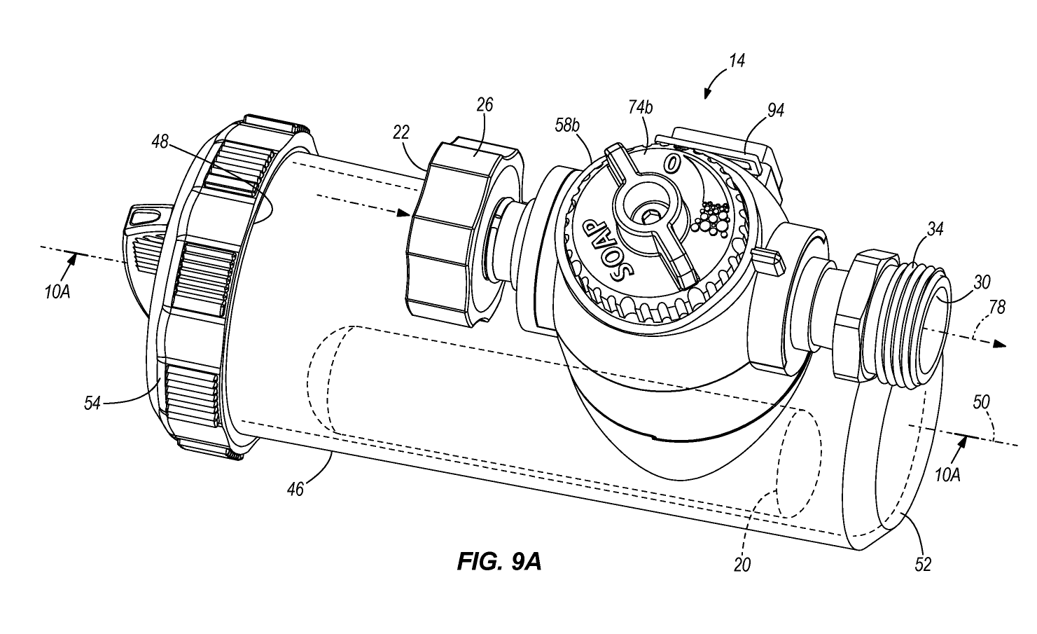

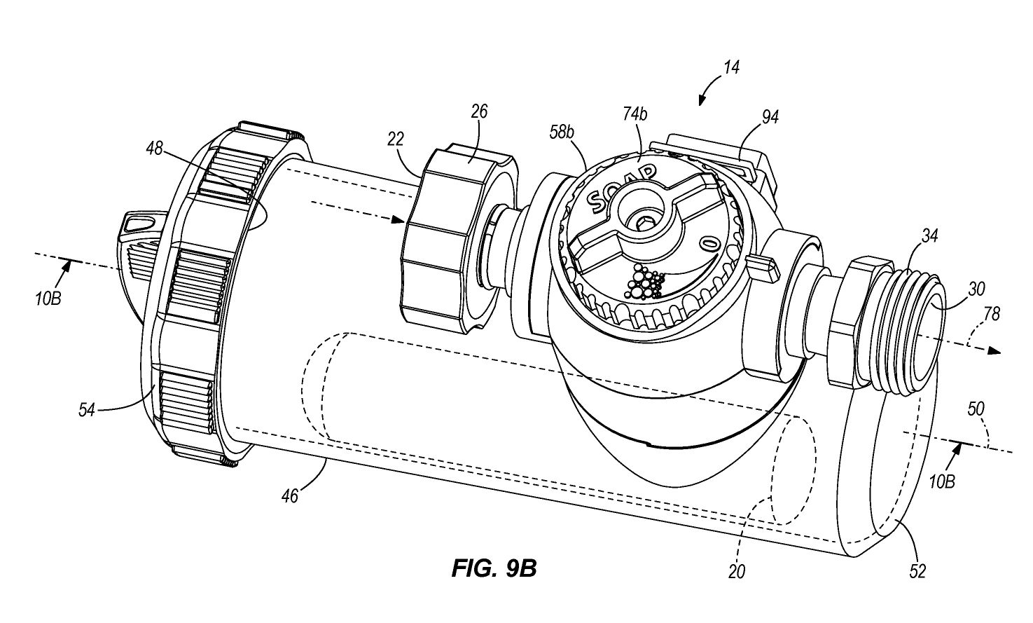

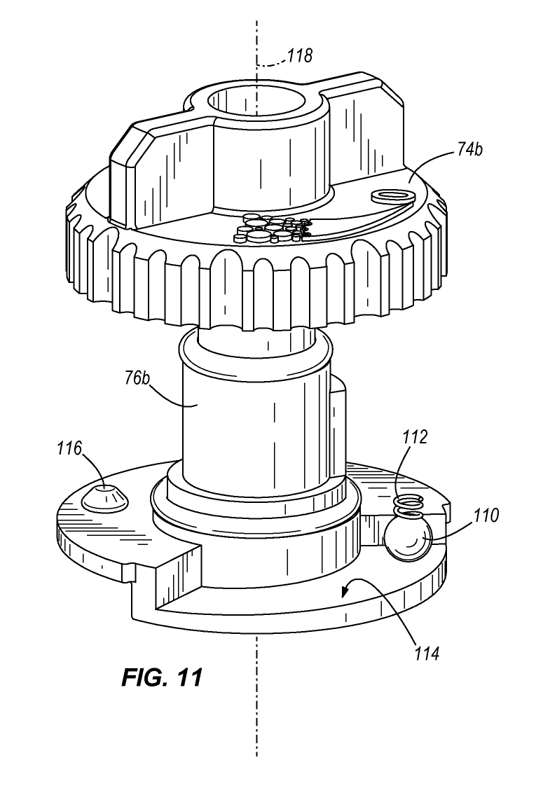

FIGS. 9A-11 relate to a third embodiment of the valve unit. Valve unit 58b in FIGS. 9A-11 is similar to valve unit 58 in FIGS. 1-6 except that valve unit 58b has continuous flow adjustment to set any flow rate between zero and a maximum flow rate of fluid entry into and exit from detergent tank 46. This feature enables regulated soap injection into the main fluid stream. As illustrated in FIGS. 9A and 9B, valve unit 58b has a control dial 74b that is rotatable between 0 and 90 degrees between a maximum detergent flow position (FIG. 9A) and a zero detergent flow position, i.e., water only (FIG. 9B). In other constructions, the dial 74b may be rotatable in a range greater than or less than 90 degrees. The control dial 74b is coupled with a control dial plate 76b. The position of the control dial 74b, and thus the control dial plate 76b, regulates the rate of detergent and water mixture that enters detergent tank 46 through a tank inlet aperture 66b and also the rate of the detergent and water mixture that exits the detergent tank 46 through a tank outlet aperture 70b. This regulation is achieved by a ball 110 and spring 112 seated in the outlet aperture 70b, a ramped surface 114 (FIG. 11), and a rubber stopper 116 coupled to the control dial plate 76b.

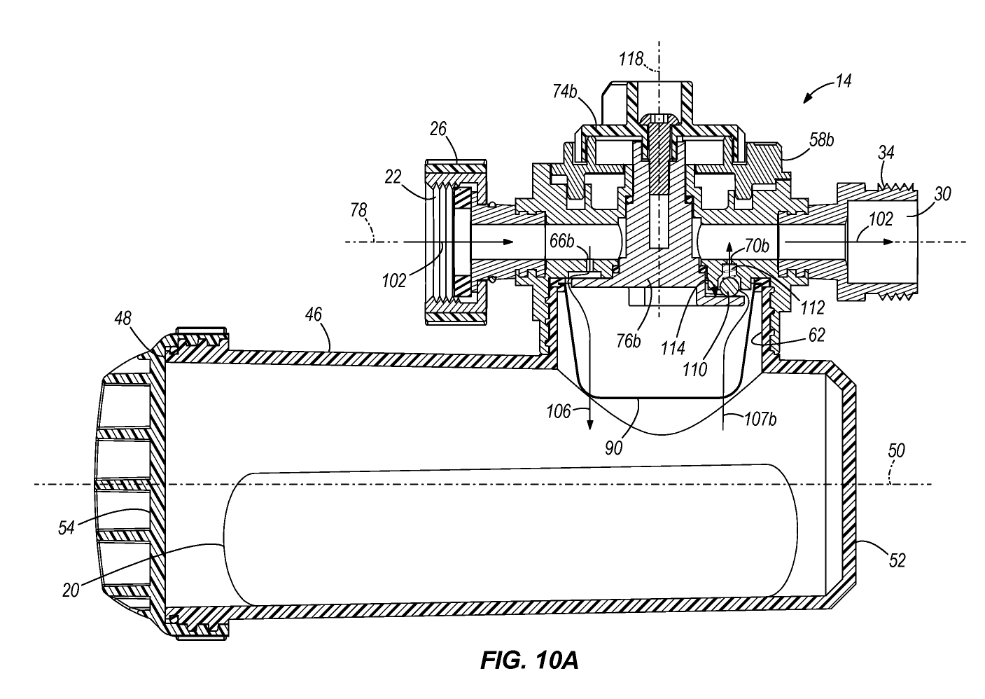

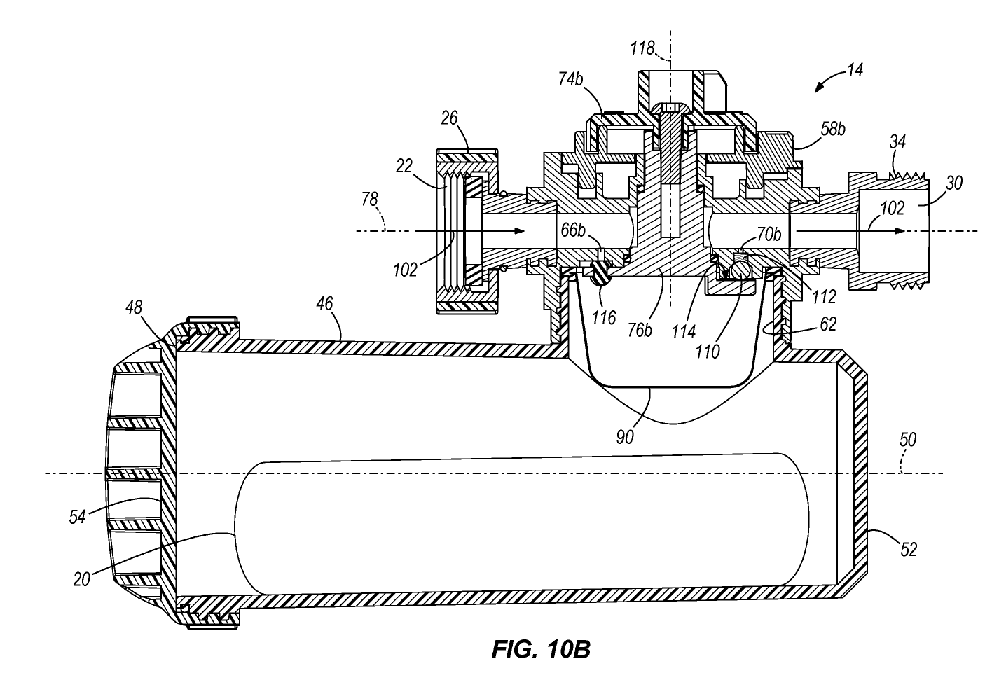

The ball 110 is biased away from the tank outlet 70b and toward the ramped surface 114 by the spring 112. The tank outlet 70b aperture includes a large diameter portion and a small diameter portion and a seat therebetween. In the maximum detergent flow position, shown in FIGS. 9A and 10A, a portion of the ramped surface 114 located adjacent the tank outlet 70b provides a large clearance, allowing the ball 110 to be situated away from the seat, and thus providing a space for a flow path 107b. The detergent and water mixture can flow past the ball 110 to join the main flow stream 102 in varying flow rates, depending on the position of the control dial 74b and control dial plate 76b. In the zero detergent flow position, shown in FIGS. 9B and 10B, a portion of the ramped surface 114 located adjacent the tank outlet 70b provides a smaller clearance such that the ball 110 is pushed against the force of the spring 112 and is seated in the tank outlet 70b to engage the seat. Thus, a flow path out of the detergent tank 46 is blocked. Furthermore, in the zero detergent flow position, the rubber stopper 116 is positioned adjacent the tank inlet 66b such that a flow of water into the detergent tank 46 is also blocked.

The ramped surface 114, best illustrated in FIG. 11, is angled or sloped with respect to the central axis 50, and is non-perpendicular to a central axis of rotation 118 of the control dial 74b and control dial plate 76b. The central axis of rotation 118 is substantially perpendicular to the central axis 50 of the detergent tank 46.

In intermediate positions between the maximum detergent flow position and the zero detergent flow position, the ball 110 is biased into engagement with the ramped surface 114 by the spring 112 to provide varying clearances, and thus varying flow rates, between the ball 110 and the seat of the tank outlet 70b depending on the distance between the seat and the ramped surface 114 in a particular intermediate position.

Thus, the invention provides, among other things, a compact detergent injector 14 that is supported by the pressure washer frame 98 and provides a main flow stream of fluid and a secondary or parallel flow stream of fluid that flows concurrently and alongside the main flow stream. In the secondary or parallel flow stream, a portion of the fluid from the main flow stream mixes with detergent in the detergent tank 46 to become a detergent solution, which rejoins the main flow stream of fluid and exits the device 14 upstream of the high pressure pump system 18 of the pressure washer 10.

Compactness is an important feature of the present invention. Typical prior art systems require a remote detergent container connected to the wand by a detergent delivery line. When the wand is moved away from the pressure washer power unit during use, the detergent container must be moved along the ground. The compact detergent chamber adjacent the wand in the present invention avoids the bulk of such prior art detergent delivery systems.

What is claimed is:

1. A pressure washer, comprising:
a frame;
a power unit supported by the frame;
a pump driven by the power unit, the pump for raising the pressure of a fluid from a fluid source;
a detergent tank positioned upstream of the pump and configured to hold a cleaning solution, the tank being closed from the atmosphere and configured to be pressurized to at least a pressure of the fluid source, the detergent tank having a tank inlet configured to receive the fluid from the fluid source and a tank outlet configured to provide a mixture of the fluid and the cleaning solution to the pump.

2. The pressure washer of claim 1, wherein the detergent tank is supported by the frame, and wherein the detergent tank is substantially cylindrical.

3. The pressure washer of claim 1, further comprising a high pressure nozzle configured to receive a high pressure fluid from the pump and configured to spray the high pressure fluid to a cleaning surface, wherein the high pressure fluid from the pump includes the cleaning solution.

4. The pressure washer of claim 1, further comprising a detergent injector assembly comprising the detergent tank and further comprising a valve coupled to the detergent tank, wherein the detergent injector assembly includes:
an inlet configured to receive the fluid from the fluid source;
an outlet configured to provide the mixture of the fluid and the cleaning solution to the pump;
a first flow path between the inlet and outlet that bypasses the detergent tank; and
a second flow path between the inlet and outlet that includes the detergent tank.

5. The pressure washer of claim 4, wherein the detergent injector assembly is configured such that the first flow path directs the fluid from the fluid source and the second flow path directs the fluid and the detergent.

6. The pressure washer of claim 4, wherein the valve is configured to close and open the second flow path.

7. The pressure washer of claim 6, further comprising a dial coupled to the valve and movable between a first position and a second position, wherein the detergent injector assembly is configured such that the second flow path is closed in the first position and the second flow path is open in the second position, and the first flow path is open in the first position and in the second position.

8. The pressure washer of claim 4, further comprising a mesh screen disposed in the second flow path between the tank inlet and the tank outlet.

9. The pressure washer of claim 4, wherein the detergent injector assembly is supported by the frame.

10. A detergent injector, comprising:
an inlet configured to receive a fluid from a fluid source at a pressure greater than atmospheric pressure;
an outlet configured to output a mixture of the fluid and a detergent;
a detergent tank positioned between the inlet and the outlet and configured to contain a cleaning solution and receive the fluid at the pressure of the fluid source;
a first flow path between the inlet and the outlet that bypasses the detergent tank; and
a second flow path between the inlet and the outlet and directed through the detergent tank.

11. The detergent injector of claim 10, further comprising a mesh screen disposed in the second flow path.

12. The detergent injector of claim 10, further comprising a valve positioned between the inlet and the outlet, the valve being configured to move between a closed position and an open position wherein the second flow path is obstructed in the closed position and unobstructed in the open position.

13. The detergent injector of claim 12, wherein the valve is configured such that the first flow path is unobstructed when the valve is in the closed position and in the open position.

14. The detergent injector of claim 12, wherein the open position is a first open position that allows the fluid to flow at a first flow rate through the detergent tank, the valve further comprising a second open position allowing the fluid to flow at a second flow rate through the detergent tank, wherein the second flow rate is different than the first flow rate.

15. The detergent injector of claim 10, wherein the detergent tank is a substantially cylindrical container having a first end, a second end, and a substantially cylindrical surface therebetween.

16. The detergent injector of claim 15, further comprising an opening in the substantially cylindrical surface configured to receive a valve.

17. The detergent injector of claim 15, further comprising a removable cap coupled with the first end of the detergent tank configured to permit refilling of the detergent tank with the cleaning solution.

18. A method of injecting a cleaning solution into a stream of fluid, the method comprising:
receiving a fluid from a fluid source at a pressure greater than atmospheric pressure;
directing a first portion of the fluid to a pump;
directing a second portion of the fluid separately from the first portion upstream of the pump;
mixing the second portion of the fluid with a detergent, and then mixing the second portion with the first portion to form a mixture upstream of the pump; and
raising the pressure of the mixture in the pump.

19. The method of claim 18, further comprising:
selecting a first mode in which all fluid from the fluid source is directed to the fluid pump; and
selecting a second mode in which the first portion is directed to the fluid pump and the second portion is directed to a detergent tank upstream of the fluid pump prior to being directed to the fluid pump.

20. The method of claim 19, further comprising directing the mixture to a high pressure nozzle downstream of the pump.
